(19) United States
(12) Patent Application Publication
(10) Pub. No.: US 2023/0301468 A1
(43) Pub. Date: Sep. 28, 2023

(54) DEVICE FOR DELIVERING AND REHEATING FOOD

(71) Applicant: Nikolay Alexandrovich NOVOSELOV, Rostov-na-Donu (RU)

(72) Inventor: Nikolay Alexandrovich NOVOSELOV, Rostov-na-Donu (RU)

(21) Appl. No.: 18/023,011

(22) PCT Filed: Aug. 24, 2021
(86) PCT No.: PCT/RU2021/050276

§ 371 Date: Feb. 24, 2023

(30) Foreign Application Priority Data
Aug. 26, 2020 (RU) 2020128407

(51) Int. Cl. A47J 47/14; A47J 36/24

(52) U.S. Cl. CPC A47J 47/14; A47J 36/2405

(57) ABSTRACT

The invention relates to devices for reheating food. The technical result consists in being able to use a device for delivering and simultaneously reheating and/or cooking food. The device for delivering and reheating food comprises a housing, which contains a food heating container, a container for a hot medium, and a switching module which switches over between different operating modes of the device. Moreover, the container for the hot medium is in the form of a thermally insulated vessel which is connected to the heating container by a medium exchange conduit. The medium exchange conduit is in the form of two conduits—a conduit for supplying the hot medium from the thermally insulated vessel to the food heating container, and a conduit for returning the medium from the food heating container to the thermally insulated vessel, and the switching module is connected to a pump for pumping the medium and to a power supply.

### FIELD OF TECHNOLOGY TO WHICH THE INVENTION RELATES

The invention relates to devices for carrying and heating food. The technical result consists of being able to use the device for delivering and simultaneously reheating and/or cooking food. The device includes a housing in which a food heating container is located, a container for a hot medium, and a switching module that regulates various modes of operation of the device.

### LEVEL OF TECHNOLOGY

The growing trend of food delivery has demonstrated weaknesses and limitations in the existing systems:

1. Low logistics efficiency: the courier spends up to 70 percent of the time on commercially inefficient activities: loading goods and returning to the base.

2. High demand for delivery within 15-30 minutes is becoming a market driver on the one hand and a barrier for many establishments on the other: in fact, delivery-oriented dishes should be able to be cooked within 10 minutes.

Reducing the delivery time even to 15-20 minutes requires:

a. Capital investments for infrastructure development. The concentration of logistical hubs should be such that the delivery is also within 5-20 minutes range. However, this is far from always effective: residential areas are empty during the day, whereas business areas—in the evening. As a result, the workload (and profitability) of such infrastructure elements is less than that of conventional catering establishments.

b. Pre-cooking the dish for the expected order (before the actual receipt of the order) allows for the increase in the territory for possible delivery covered by one establishment. On the other hand, this approach is limited by high scrap rates and higher inefficient staff workload.

3. Replacing dishes made to order with semi-finished prefabricated products made centrally long before the order. The rise of semi-finished products that are simply reheated before delivery is a technology that is now in mass use. This approach is beginning to compete directly with instant food delivery systems from stores: delivery of an unheated semi-finished product can cost 60 percent less than a heated one. Additionally, not all dishes can be prepared this way.

4. At the same time, some dishes are not suitable for delivery:
a. Steaks
b. French fries
c. A number of others, serving “from under the knife” or “from the fire/grill.”

In summary, the current concept suggests that the establishment must choose how to spend these 15-30 minutes: on delivery or for cooking.

From the Level of Technology, a device for delivering and heating food is known, including a housing in which a heating container for food is located, a container for a hot medium, a switching module that switches various modes of operation of the device is described in application No. WO2020064848, published in 2020.

This device is the closest in technical essence and achieved technical result and is chosen as the prototype of the present invention.

The disadvantage of this prototype is that it is a lunch box and is not intended for a full cycle of food preparation at the time of delivery.

### DISCLOSURE OF INVENTION

The present invention mainly aims to provide a device for delivering and heating food, including a housing in which a heating container for food is located, a container for a hot environment, a switching module that switches between various modes of operation of the device, enabling at least one of the disadvantages mentioned above to be mitigated, namely: enabling automation of the cooking process, allowing it to be activated at a precisely calculated moment, so that the end of cooking occurs at the time of delivery to the consumer, which is the task to be solved.

To achieve this goal, the medium exchange trunk-line is made in the form of two lines—a line for supplying a hot medium from a thermally insulated vessel to a heating container for food, and a line for returning medium from a heating container for food to a thermally insulated vessel, and the switching module is connected to a pump for transferring the medium and a source power supply, while the thermally insulated vessel has an environment temperature sensor located inside it, and the heating container for food has an environment temperature sensor located inside it, while the switching module has a data exchange unit configured to exchange data via wireless networks.

Due to these advantageous characteristics, it becomes possible to provide the possibility of cooking, mainly meat products, during the delivery process. That is, the preparation of the dish and the delivery process are combined so that the client receives the finished dish in the “cooking on delivery” mode. The point from which the courier picks up the delivery no longer functions as a kitchen and is replaced by a refrigerator that keeps the dish ready at the time of order before placing it in the “last mile delivery and cooking” device. The establishment prepares the dish in such a way that it only requires finalization. This allows:
1. Implement the “cooking on delivery” concept for existing dishes and optimize the supply chain
2. Add dishes to the delivery menu that were not available to customers before.
3. Guarantee the customer that the dishes in the delivery are prepared individually for him.
4. Reduce energy waste and make the delivery segment more environmentally friendly.
5. Offer healthier and fresher food than currently available for delivery.

In addition, due to these advantageous characteristics, it becomes possible to control the temperature of the hot medium, which is important for automation and remote control of the process, as well as to control the temperature of the food container, which is important for automation and remote control of the process.

And also, thanks to these advantageous characteristics, it becomes possible to automate the cooking process, making it possible to activate it at a precisely calculated moment, so that the end of cooking is at the time of delivery to the consumer.

There is also a variant of the invention in which the heating container for food has a convection line with holes located along the inner surface of the specified container, connected to a channel for supplying a hot medium from a thermally insulated vessel. Due to this advantageous feature, there is a possibility of increasing the speed of food preparation due to more active washing of the food with the hot medium.

There is also a variant of the invention in which the heating container for food has a lot of convection baffles. Thanks to this advantageous characteristic, it also becomes possible to increase the speed of cooking due to more active washing with a hot medium.

There is also a variant of the invention in which the thermally insulated vessel is made in the form of a removable thermal accumulator. This advantageous feature makes it possible to quickly change the thermal accumulators on the way at the refueling station or at the place of the departure.

Finally, there is a variant of the invention in which the heating container for food has an ultrasonic vibration source. Thanks to this advantageous characteristic, it becomes possible for further acceleration of cooking.

### BRIEF DESCRIPTION OF THE DRAWINGS

Other distinctive features and advantages of the invention are clearly derived from the description below for illustrative and non-limiting purposes, with reference to the accompanying drawings, in which:

FIG. 1 schematically depicts the stages of operation of the device for delivering and heating food, according to the invention,

FIG. 2 schematically depicts the placement of food in the device for delivering and heating food, according to the invention,

FIG. 3 schematically depicts the connection of heating containers to a thermally insulated vessel in a device for delivering and heating food according to the invention,

FIG. 4 schematically depicts the direction of the flow of the medium in the device for the delivery and heating of food, according to the invention,

FIG. 5 schematically depicts a general diagram of a food delivery and reheating device according to the invention,

FIG. 6 schematically depicts the filling of a heating container with a hot medium in a device for delivering and heating food, according to the invention,

FIG. 7 schematically depicts the circulation of a hot medium in a heating container in a device for delivering and heating food according to the invention,

FIG. 8 schematically depicts the drainage of the hot medium from the heating container in the device for delivering and heating food according to the invention,

FIG. 9 schematically depicts the placement of food in a heating container in a device for delivering and heating food according to the invention,

FIG. 10 schematically depicts the general diagram of a thermally insulated vessel in a device for delivering and heating food, according to the invention,

FIG. 11 is a schematic representation of the overall layout of a heating vessel in a food delivery and heating device according to the invention,

FIG. 12 schematically depicts the general diagram of the heating container in the device for the delivery and heating of food, according to the invention, a variant of the presence of a convection line with holes,

FIG. 13 schematically depicts the general layout of the heating container in the device for delivering and heating food according to the invention, the variant when convection baffles are present,

FIG. 14 schematically depicts the scheme of the movement of the medium in the heating vessel, according to the invention, a variant when convection partitions are present,

FIG. 15 schematically depicts a vertical section of a heating vessel according to the invention, a variant when convection baffles are present,

FIG. 16 schematically depicts the general scheme of operation of the device for delivering and heating food, according to the invention, the stage of filling with hot medium,

FIG. 17 schematically depicts the general diagram of operation of the device for delivering and heating food, according to the invention, the stage of draining the cooled medium,

FIG. 18 schematically depicts the valve system of the device for delivering and heating food, which allows mixing the medium using a switching module as a buffer and portioning of the medium inside the food preparation container from the point of taking the medium to the point of draining the medium,

FIG. 18.1 schematically depicts the first stage of the circulation of the device for the delivery and heating of food: the intake of the medium into the switching module, whereby the intake takes place through the point of intake of the medium,

FIG. 18.2 schematically depicts the second stage of the circulation of the device for the delivery and heating of food: the discharge of the medium from the switching module, in which the discharge occurs through the point or points of discharge, as a result of which the liquid moves from the point of intake of the medium to the point of discharge of the medium.

The figures indicate:
1—housing
2—heating tank
21—means of heating the hot medium of the heating container
22—temperature sensor of the medium of the heating tank
23—convection line with holes
24—convection partitions
25—ultrasonic vibration source
26—heating tank volume detector
27—heating tank dump valve
28—heating tank clamping mechanism
29—heating tank control unit
3—food (cooked dish)
4—switching module
41—hot medium transfer pump
42—valve
43—power supply
44—data exchange unit
5—thermally insulated vessel
51—means of heating the hot medium of a thermally insulated vessel
52—temperature sensor of the medium of a thermally insulated vessel
53—connectors.
6—line for supplying hot medium from a thermally insulated vessel to a heating container for food
7—line for the return supply of the medium from the heating container for food to the thermally insulated vessel
8—external switching devices
9—wireless networks

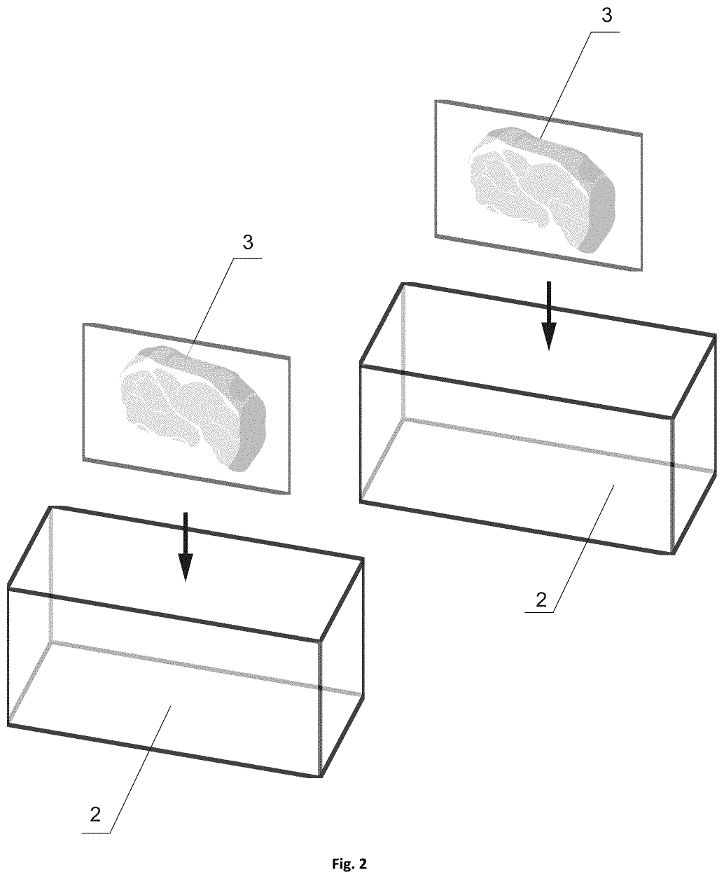

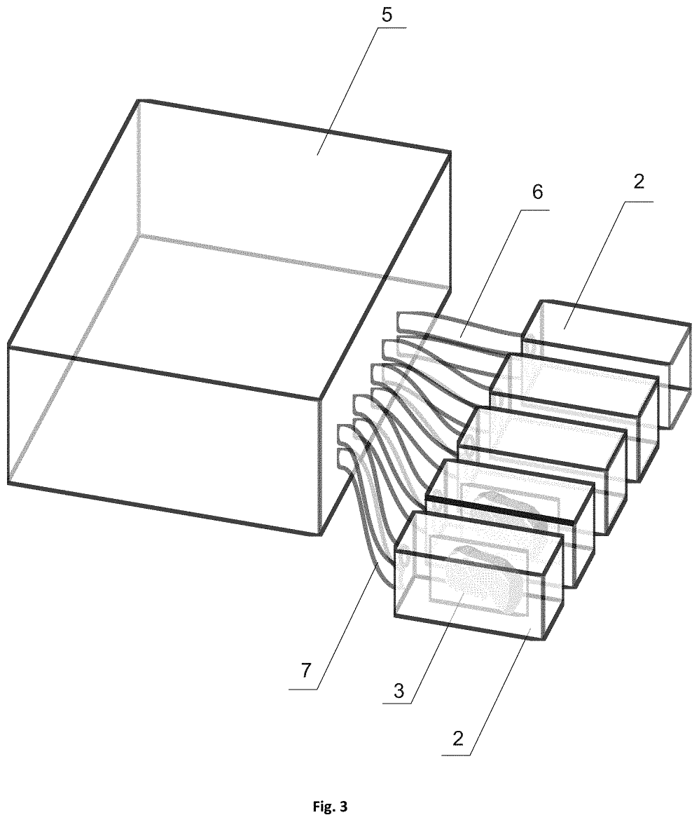

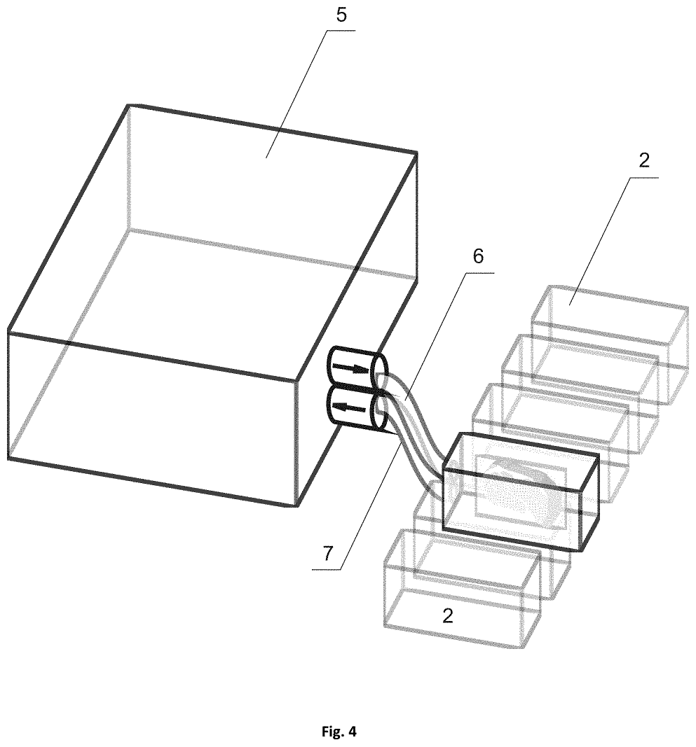

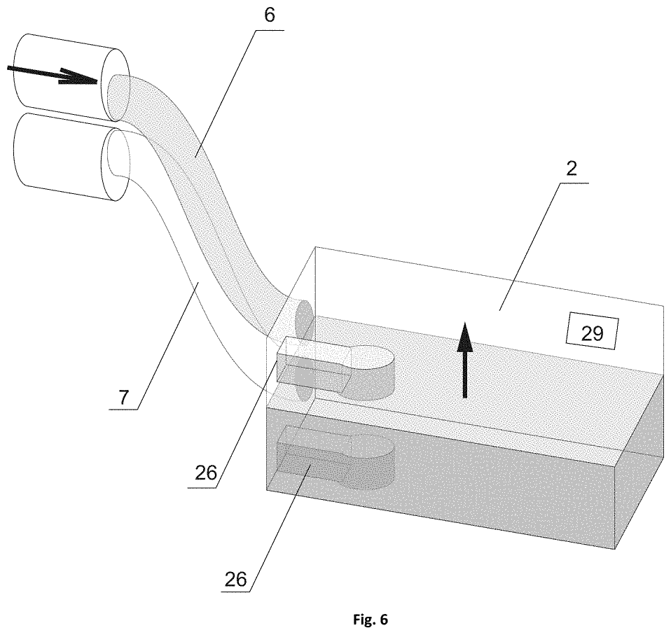

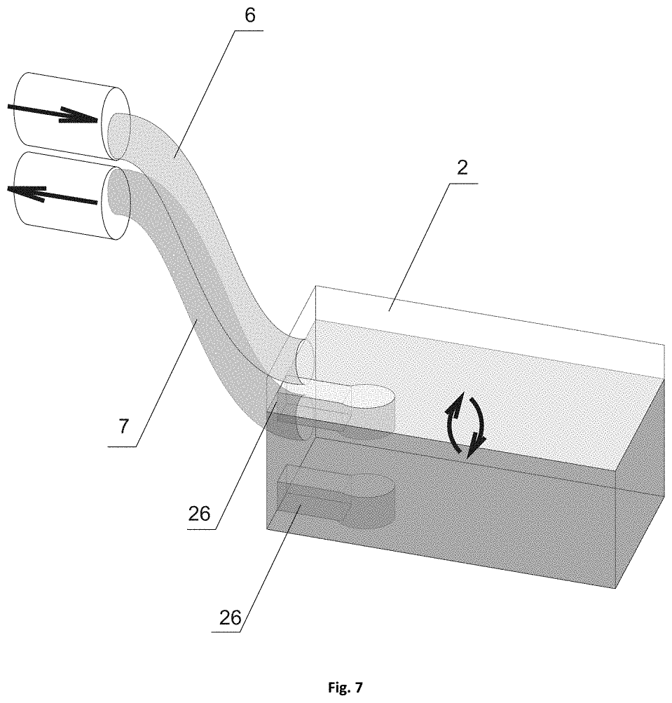

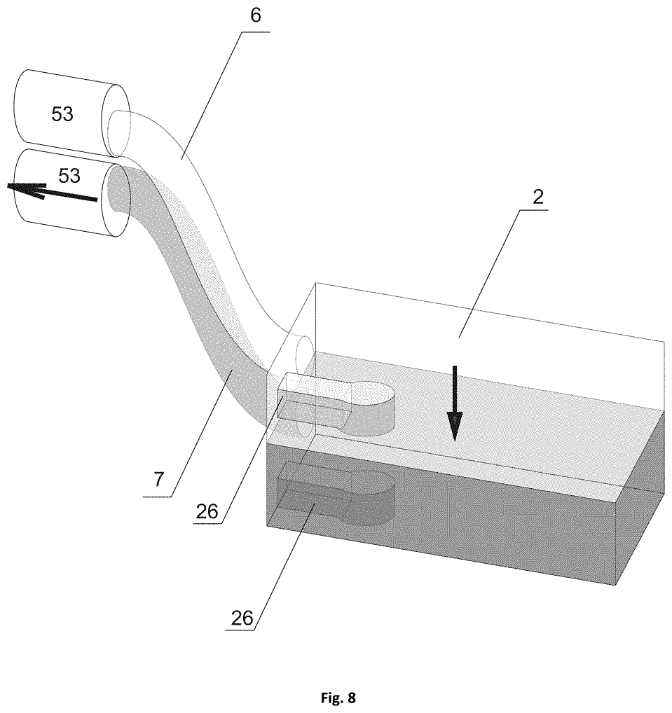

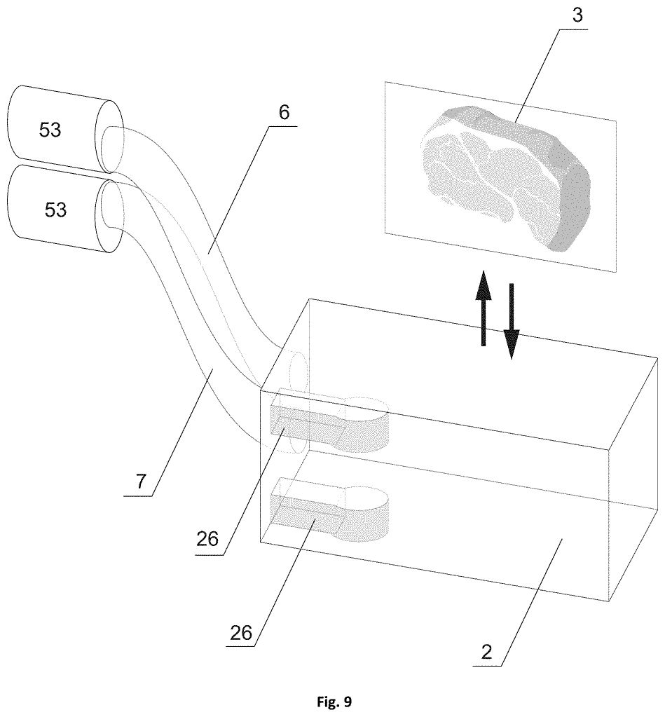

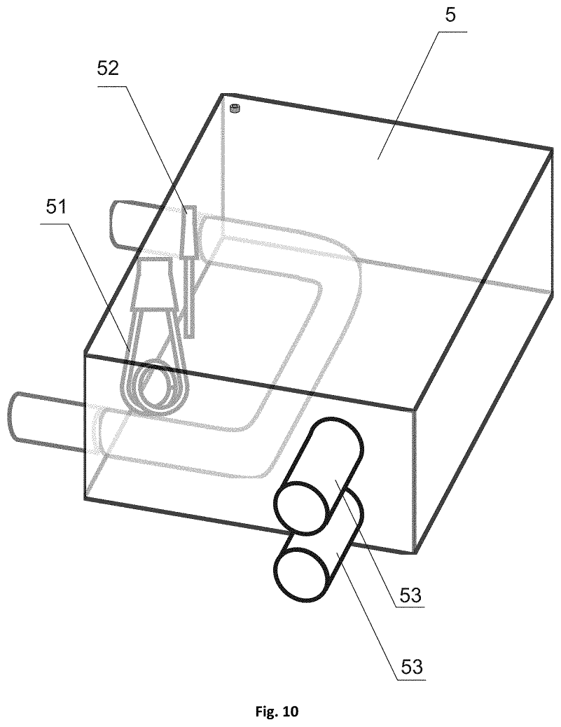

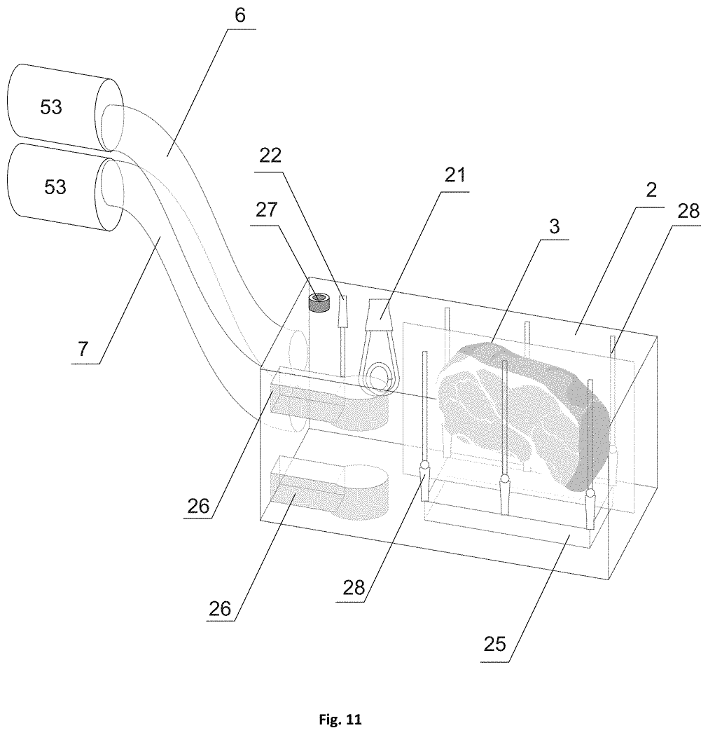

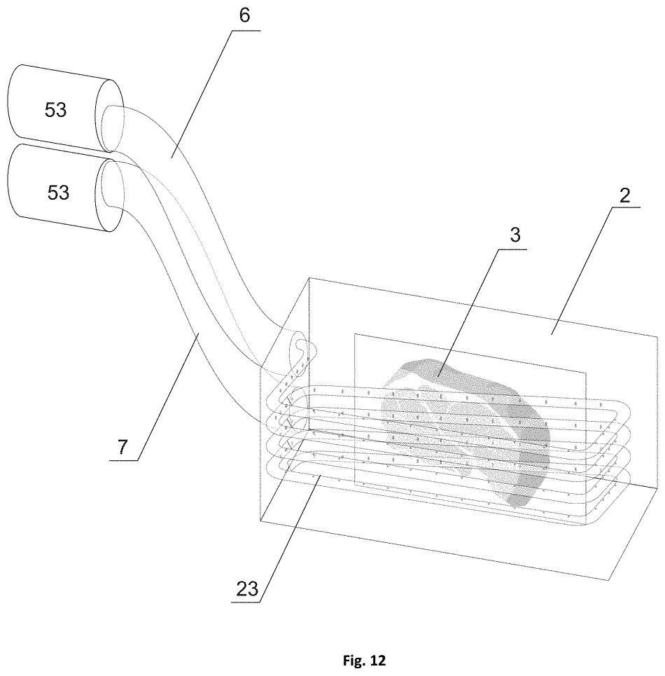

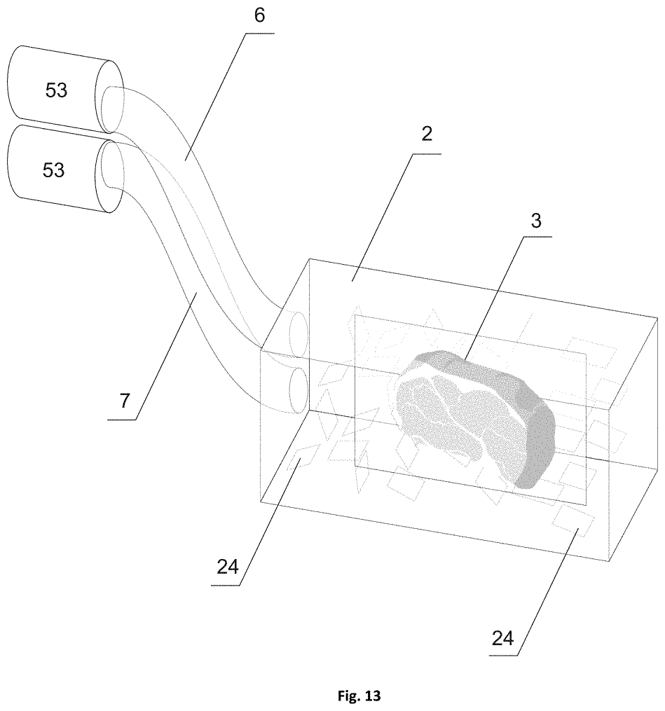

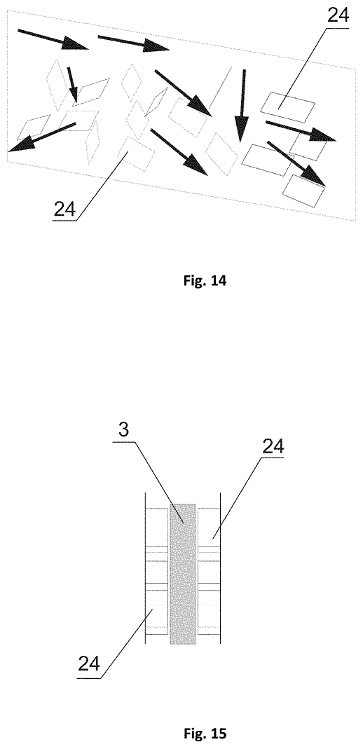

According to FIGS. 2-20, the device for delivering and heating food includes a housing 1 in which a heating container 2 for food 3 is located, a container for a hot medium, a switching module 4 that switches various modes of operation of the device.

The container for the hot medium is made in the form of a thermally insulated vessel 5, connected by a line 6 for supplying hot medium from the thermally insulated vessel to the heating vessel for food, and by a line 7 for returning the medium from the heating vessel for food to the thermally insulated vessel.

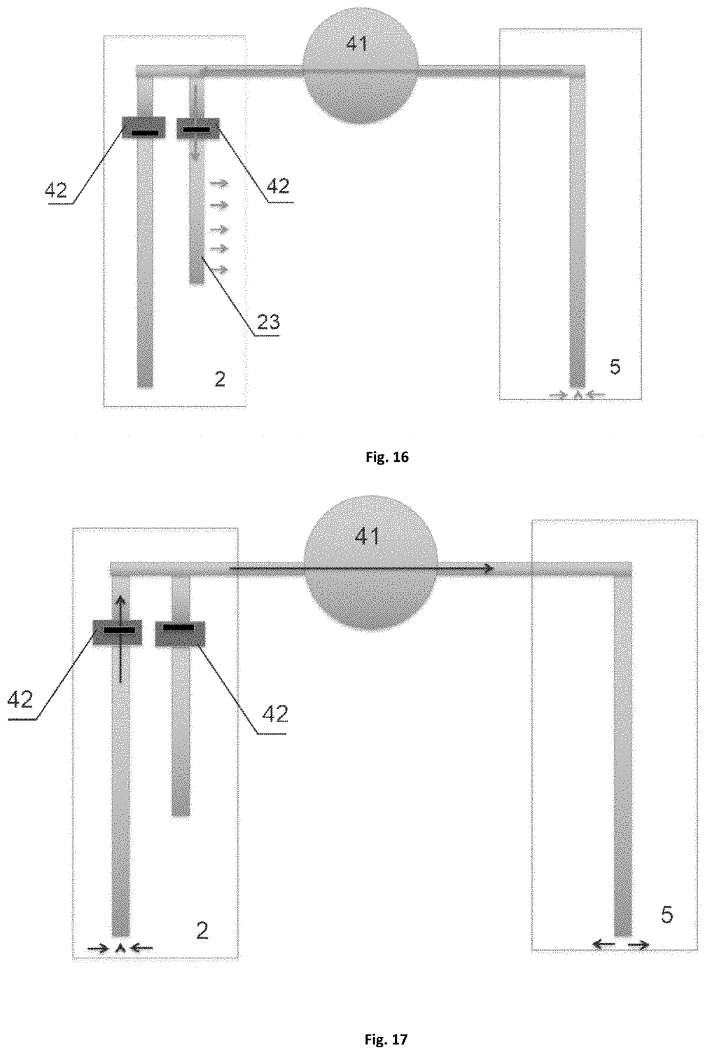

FIGS. 2-13 show an embodiment of a device with two lines 6 and 7, and FIGS. 16-20 show an embodiment of a device with a single line.

By putting together the two lines within one trunk-line allows the realization of function of mixing the medium with one pump, without using a separate pump, vibrator (sonic or ultrasonic) or mixer.

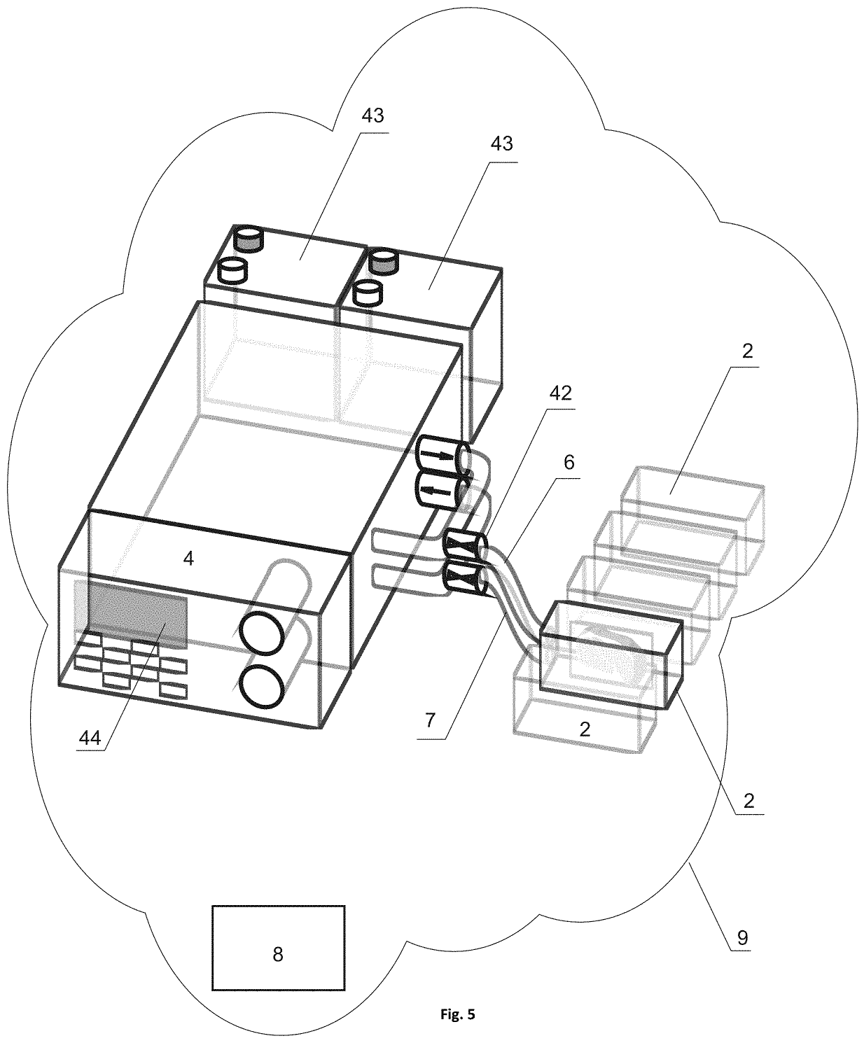

According to FIG. 5, the switching module is connected to the hot medium transfer pumps 41, which are connected to the valves 42 and the power supply 43.

Optionally, the thermally insulated vessel 5 can be connected by a plurality of hot medium supply lines 6 from the thermally insulated vessel 5 to the plurality of food heating containers, and by a plurality of return medium supply lines from the plurality of food heating containers to the thermally insulated vessel.

Optionally, there can be several thermally insulated vessels, and they are connected by multiple lines for supplying a hot medium from thermally insulated vessels to multiple heating containers 2 for food, and by a multiple lines 7 for returning medium from multiple heating containers for food to thermally insulated vessels 5.

Optionally, the thermally insulated vessel 5 may have a means for heating the hot medium 51 located inside it.

Optionally, the thermally insulated vessel 5 can have a medium temperature sensor 52 located inside it.

Optionally, the heating container for food 2 may have a means of heating the hot medium 21 located inside it.

Optionally, the heating container 2 for food can have a medium temperature sensor 22 located inside it.

Optionally, the heating container for food can have a convection line 23 with holes located along the inner surface of the specified container, connected to a channel for supplying a hot medium from a thermally insulated vessel.

Optionally, the heating container for food 2 may have a plurality of convection baffles 24.

Optionally, the switching module 4 may have a data exchange unit 44 with external devices 8 via wireless networks 9.

Optionally, the thermally insulated vessel can be made in the form of a removable thermal accumulator.

Optionally, the heating container for food 2 may have a source of ultrasonic vibrations 25.

A liquid, such as water, can be used as the medium. But in general, it can be another liquid, such as oil, as well as a gas. In the examples, for simplicity, water is used as the hot medium.

As can be seen in FIGS. 2-20, the thermally insulated vessel 5 contains a high temperature, high volume liquid. The thermally insulated vessel is hermetically sealed. The temperature in it is maintained by the means 51 of heating the hot medium of the thermo-isolated vessel (TEN heater) and the temperature sensor 52.

The means 52 of heating the hot medium of the insulated vessel is powered by a power source (for example, a mobile battery). It is recommended to fill the liquid already hot through the connectors 53. However, it is possible to fill the liquid below the target temperature. The target temperature is set by the switching module 4.

Thermally insulated vessel 5 may have additional sources of heating, such as: solar energy, the transport engine cooling system or a chemical reaction. In some cases, additional heating sources may be the main ones.

Food 3 (steak, offal, sauce, garnish, etc.) is sealed in a vacuum and placed in a heating container 2. On control command, the heating container 2 is filled with liquid from a thermally insulated vessel 5 through line 6, using pumps 41 and valves 42.

The liquid circulates: hot liquid is supplied from the thermally insulated vessel 5 as needed; the liquid is pumped out of the heating vessel 2. Food 3 does not interact with the liquid, as it is in a protective vacuum packaging.

Inside the heating container 2, the liquid is maintained at a level determined by the device using sensors 22 for the temperature of the medium of the heating container.

At the beginning of the cycle, the heating container 2 may be empty (no liquid) and may contain liquid with impurities of the frozen state of the liquid itself.

The heating vessel 2 is sealed and contains a relief valve 27 in case of steam release or critical overflow.

The heating tank 2 is connected by two lines 6 and 7 with a thermally insulated vessel 5, which can be several.

The heating container 2 can be equipped with an additional source of heating—means for heating the hot medium of the heating container 21, as well as a temperature sensor 22 of the medium of the heating container.

In some cases, additional heating sources 21 can be the main source.

The heating vessel 2 may be equipped with an oscillating wave source to create convection within the heating vessel 2 and/or within the food 3.

Steam or hot air heating may be used instead of liquid supply. Thus the hot environment can be different.

An optional passive convection enhancement system works inside the heating tank 2 to redistribute the heat evenly around the food and also to reduce the shock temperature rise when the liquid is supplied from the tank. The passive system may consist of a convection line with orifices 23 connected directly to the supply line 6 or convection baffles 24 built into the heating tank 2.

Also, the convection system may consist of small diameter holes that supply hot liquid. Due to the small cross-section, the liquid exits under pressure and with high pressure, which causes it to mix the liquid existing in the cassette, thereby improving the uniformity of temperature distribution without the use of additional devices.

Other versions are also possible that perform the functions of improving the uniformity of heating of the contents of the cassette:
a system for enhancing convection in a vessel based on capillaries;
a system for enhancing convection in the vessel, based on guides;
the principle of separation of flows and convection with guides.

Convection partitions 24 can simultaneously be guides (frames) for fastening the food object 3 that is being cooked.

In the heating tank 2, the convention acceleration system can optionally be operated. Depending on the object and place of work of the convention, one of the following basic principles works:
1. Mechanical vibrations. The food object 3 is mounted on a metal frame, which is fixed on a rigid or flexible mount, to which a vibrator is attached and creates vibrations of the food 3 and inside the heating container 2.
2. Bending the object. Food 3 is attached to a metal frame, which is fixed to a rigid or flexible mount, to which a motor is attached. The motor through the system of fasteners creates a curvature of the surface of the food.
3. Sound vibrations. Food 3 is attached to a sound-conducting frame, which is fixed to a solid or flexible mount, to which a sound vibrator is attached and creates food vibrations inside the heating container 2.
4. Ultrasonic vibrations. Food 3 is attached to a frame that conducts ultrasound, which is fixed to a solid or flexible mount, to which an ultrasonic vibrator is attached and creates oscillations of the object inside the heating container 2.
5. Vibration flow. Food 3 is attached to the frame, which is fixed inside the heating container 2. The rotor with the liquid flow, which changes the direction of the liquid flows, creates vibrations.

The device can be equipped with removable heating containers 2. Then the heating container 2 includes a number of connections that minimize water leakage when disconnecting/connecting such a container.

The “male” connection is in the tank. It can be equipped with valves or pumps.

The “female” connection is located in the heating tank 2. It can be equipped with an automatic valve that is activated when connected/disconnected from the heating tank 2 due to the return spring.

The fastening of the heating container 2 in the housing can be carried out using the clamping mechanism 28. For example, with a clamping contact plate, which is placed in the groove and is clamped by the clamping mechanism fixed in the flexible groove and holes using a guide lever with a handle that can move down. At this moment, the clove falls into the groove on the heating container 2 and fixes its position.

The coverlid of the heating vessel 2 is chosen such that it provides:
1. Simple closing mechanism.
2. High tightness under shock and vibration loads.
3. Resistance to high temperatures.
4. Access to the cassette in a small space.

Material of coverlid and/or heating container 2 from top to bottom:
plastic
foamed polymer
plastic
rubber.

A hinge can be located on the lid, which is attached to the protrusions. On the other side, the mating tabs have a design in which the comb tabs go in. They provide reliable fastening with load distribution on several ledges. The comb moves in the grooves of the lid, which ensure ease and correct movement. Snapping occurs with the help of a return spring. Opening with handle.

The walls of the heating container 2 are such that they contain a highly effective heat insulator integrated into them.

The thermal insulation of the heating tank 2 is also controlled by the control unit 29. Main functionality:
1. Controls the heating tank
2. Contains an independent temperature sensor of the environment of the heating tank 22.
3. Has built-in safety systems: pressure release, liquid release, heating shutoff
4. Can be connected with video sensors, GPS, accelerometer.

Layout options.

Heating tanks can be located in various ways within the body of the device, which can have a different form factors. The main options for installing the entire device:
1. Scooter, moped, bike. The device can be placed in the trunk of the scooter, the location option with access from the side. The device can be placed in the scooter's trunk, top-access location option.
2. The device can be placed on a specialized tricycle with an optional engine (trike). Location access options with top or side access.
3. The device can be placed inside the delivery robot. Location access from top, and the ability to pick up the parcel by the final recipient.
4. The device can be placed inside the car trunk. Power can then be supplied from the electrical system of the vehicle.
5. The device can be placed in the trunk of a specialized van. The increased capacity of the thermally insulated vessel, a large number of heating containers and power supply from the heat—electric system of a specialized van are used.
6. In a backpack or courier bag.

The device may have two quick-detachable batteries 43, which can duplicate the functions of each other, acting as a backup battery for another part of the circuit.

The device involves refilling with high temperature liquid as needed. This approach saves the charge and life of removable batteries. The fluid change also ensures that the system is flushed in “flush mode”.

### Implementation of the Invention

Device for delivery and heating of food works as follows.

Stage 1. Prepared dishes (food) 3 are placed in heating containers 2, which are small vessels that are hermetically sealed. Placement of food 3 in the heating vessels 2 can be any.

Stage 2. All heating containers 2 are connected to a thermally insulated vessel 5—a large vessel that contains a hot medium, mainly a liquid of a certain temperature.

Stage 3. Connection of the heating containers 2 to the thermally insulated vessel 5 can be implemented in various ways: through separate pumps 41 for pumping hot medium and line 6 for supplying hot medium from the thermally insulated vessel to the heating container for food.

Step 4: Power is provided by the power supply 43 (mobile battery or AC power).

Step 5. The device is controlled by an external switching device (for example, a mobile device) 8.

The cycle of cooking a single object food.

Stage 6. When the cooking mode is activated in heating tanks 2, the pump 41 or valve 42 turns on, and fills the heating tank 2 with hot medium (liquid) from the thermally insulated vessel 5 through line 6. Shown in FIG. 16 is the option when lines 6 and 7 are combined into one, and two valves 42 are used, one for supplying the medium, the second for draining. The moment of filling the tank 2 is shown.

Stage 7. Since the heating container 2 contains food 3, which initially has a much lower temperature than the liquid in the thermally insulated vessel 5, the temperature in the heating container 2 (together with food 3) can be fixed at any temperature lower than or equal to the temperature of the thermally insulated liquid vessel 5, but above the food temperature.

Stage 8. The set temperature inside the heating vessel 2 is maintained constant by regulating the exchange of liquids inside the heating vessel 2 and inside the thermally insulated vessel 5.

Step 9. Pump 41 and valve 42 are turned on and they pump liquid out of the volume of heating vessel 2 through line 7. Hotter liquid continues to flow through line 6 and fills heating vessel 2 with hot liquid, which raises or maintains the overall temperature in heating vessel 2 around a certain value.

The FIG. 17 shows the moment of pumping out, when the colder medium from the bottom of the tank 2 is pumped out.

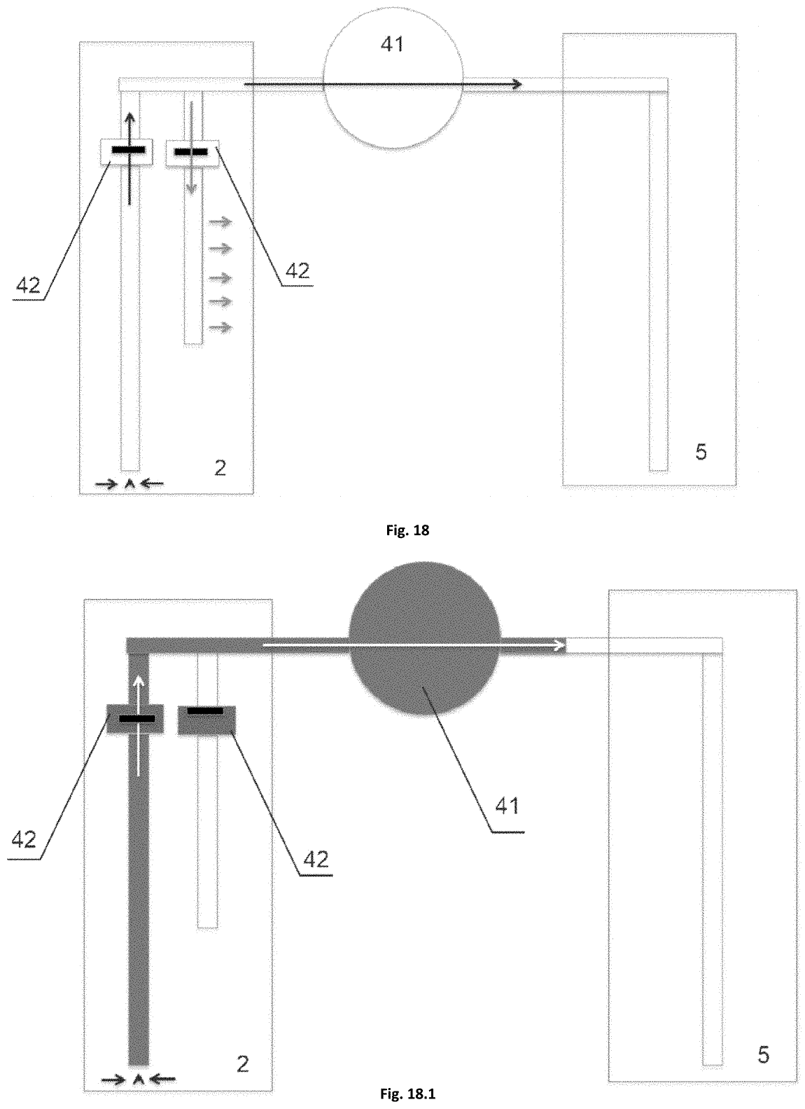

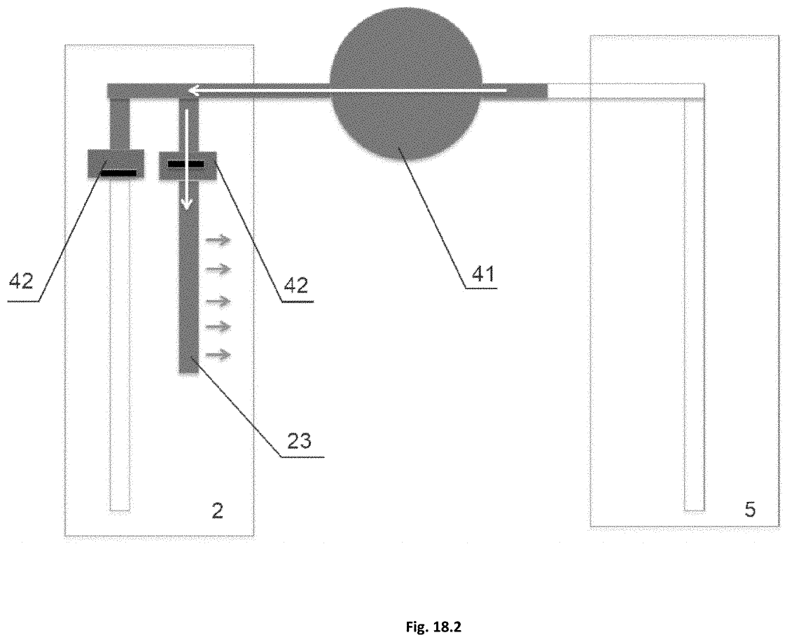

FIG. 18 shows the moment of circulation when the hot medium is supplied and at the same time the colder medium is pumped out from the bottom of the container 2.

Step 10: The volume detector 26 prevents the liquid from exceeding the critical volume of the cassette.

Step 11. After the end of the cooking process 3, all the liquid is pumped out and the operator can safely open the heating container 2 and pick up the cooked food 3 and/or load the next one.

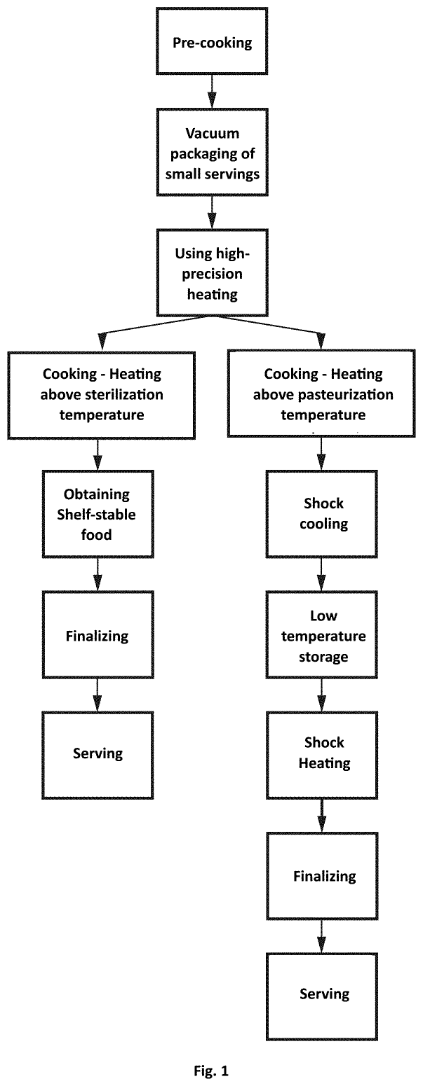

The FIG. 1 also shows a possible schematic diagram of operation.

The device can operate in the following modes:
1. Cooking on a mobile platform.
2. Self-service cooking.
3. In self-service mode (vending machine with/without attendants).
4. Restaurant use for mass cooking automation.
5. In the sharing of automation and delivery (using 2 heating tanks).

### INDUSTRIAL APPLICABILITY

The device for delivery and heating of food can be implemented by a specialist and once implemented provides the realization of the stated purpose, which allows us to conclude that the criterion are met for “industrial applicability” for the invention.

In accordance with the proposed invention, a prototype of a device for the delivery and heating of food was made.

Testing of a prototype system has shown that it provides the ability to cook food at the time of delivery.

Thus, due to the fact that the medium exchange line is made in the form of two lines—a line for supplying a hot medium from a thermally insulated vessel to a heating container for food, and a line for returning a medium from a heating container for food to a thermally insulated vessel, and the switching module is connected to the pump pumping medium and a power source, while the thermally insulated vessel has a medium temperature sensor located inside it, and the heating container for food has a medium temperature sensor located inside it, while the switching module has a data exchange unit configured to exchange data via wireless networks and the claimed technical result are achieved, namely: the possibility to automate the cooking process, allowing to activate it at a precisely calculated moment so that the end of cooking falls at the time of delivery to the consumer.

An additional useful technical result of the claimed invention is that:
cooking can be controlled automatically;
cooking is carried out with the help of a heat transfer medium, which allows a dosed amount of energy to used for cooking object;
the heat medium can function for a long time (many cooking cycles and its heating);
the heat medium is in contact with the food packaging, without dissolving the food or its traces in it;
the device allows you to safely operate it in mobile mode;
optionally, it is possible to operate the device without heating elements;
energy is stored in the form of heat and placed inside a heat-insulated vessel. The heat transfer medium can be heated outside the mobile device.
energy recovery is carried out. Unused energy is not dissipated, but stored in the heat medium. When reusing the heat medium, it is only necessary to add a small portion of energy to it.

1. A device for delivering and reheating food, comprising
a housing in which a food heating container is located,
a hot medium container,
a switching module switching various modes of operation of the device, wherein
the hot medium container is made in the form of a the thermally insulated container, connected by medium exchange trunk-line to the food heating container, wherein
the medium exchange trunk-line is made as two lines—
a trunk-line for supplying hot medium from the thermally insulated container to the food heating container, and
a return trunk-line for supplying the medium from the food heating container to the thermally insulated container, and
the switching module is connected to the medium transfer pump and the power supply, wherein
the thermally insulated container has a temperature sensor located within and
the switching module having a data exchange unit configured to communicate over the wireless networks.

2. The device of claim 1, wherein the food heating container has a convection line with holes, located on the inner surface of said container, connected to the channel of hot medium from a thermally insulated container.

3. The device of claim 1, wherein the food heating container has a plurality of convection baffles.

4. The device of claim 1, wherein the thermally insulated container is in the form of a removable thermal reservoir.

5. The device of claim 1, wherein the heating food container has a source of ultrasonic vibrations.
